(19) United States
(12) Patent Application Publication
(10) Pub. No.: US 2020/0311097 A1
(43) Pub. Date: Oct. 1, 2020

(54) DATA CONVERSION SERVER AND COMPUTER PROGRAMS

(71) Applicant: TMAXSOFT.CO., LTD., Gyeonggi-do (KR)

(72) Inventors: Hwantae JI, Seoul (KR); Sinwoo KIM, Seoul (KR); Hyunjoo YI, Gyeonggi-do (KR); Pyoung-Woo PARK, Gyeonggi-do (KR); Yeongha LEE, Gyeonggi-do (KR)

(21) Appl. No.: 16/383,977

(22) Filed: Apr. 15, 2019

(30) Foreign Application Priority Data
Mar. 27, 2019 (KR) 10-2019-0035095

(51) Int. Cl. G06F 16/25; G06F 16/958; G06F 9/451; G06F 17/22; G06F 17/21; G06F 3/0484

(52) U.S. Cl. CPC G06F 16/258; G06F 16/986; G06F 3/04847; G06F 17/2247; G06F 17/211; G06F 9/451

(57) ABSTRACT

Disclosed is a computer readable storage containing a computer program including commands which cause a computer to execute steps and the steps may include: receiving a first data set from a mainframe; converting the first data set into first data of a JSON (JavaScript Object Notation) type for generating a web page; generating a web page based on the first data; and transmitting the web page to the web browser so that the web page is output through the web browser, and the webpage may allow user interaction.

### CROSS-REFERENCE TO RELATED APPLICATIONS

This application claims priority to and the benefit of Korean Patent Application No. 10-2019-0035095 filed in the Korean Intellectual Property Office on Feb. 20, 2019, the entire contents of which are incorporated herein by reference.

### TECHNICAL FIELD

The present disclosure relates to a data conversion server and computer programs stored in a computer readable storage.

### BACKGROUND ART

A lot of mainframe systems were introduced in the 1960s to 1970s by the government, financial institutions and large corporations to handle various data needed for business activities. The mainframe system is a general-purpose large-scale computer that performs various tasks by adopting a centralized method of connecting a plurality of terminals to one computer and corresponds to, for example, IBM System/360 or the like. Meanwhile, the mainframe system outputs data through an external terminal. Specifically, when the data stored in a mainframe is output to the external terminal, the external terminal outputs the data by using a specific emulator (e.g., 3270 emulator) program corresponding to the mainframe according to a specific protocol (e.g., IBM 3270 protocol). In this case, the external terminal expresses the data provided by the mainframe system as it is without processing the data and may not modify the data provided by the mainframe system, resulting in a problem of poor scalability.

Accordingly, there is a demand for a solution that can represent the data provided by the mainframe system in various ways and can easily modify the data of the mainframe system.

### SUMMARY OF THE INVENTION

The present disclosure has been made in an effort to provide a data converter server for displaying a data set of a mainframe in various forms in a user terminal and computer programs stored in a computer readable storage.

However, technical objects of the present disclosure are not restricted to the technical object mentioned as above. Unmentioned technical objects will be apparently appreciated by those skilled in the art by referencing to the following description.

An exemplary embodiment of the present disclosure provides a computer program stored in a computer readable storage. The computer program may include commands which cause a processor of a data conversion server to execute steps and the steps may include: receiving a first data set from a mainframe; converting the first data set into first data of a JSON (JavaScript Object Notation) type for generating a web page; generating a web page based on the first data; and transmitting the web page to the web browser so that the web page is output through the web browser, and the web page may allow user interaction.

The converting of the first data set into first data of a JSON (JavaScript Object Notation) type may include: converting the first data set created in an EBCDIC (extended binary-coded decimal interchange code) type into UTF-16 (16-bit Unicode Transformation Format) type; storing the first data set converted into the UTF-16 type as a Java object; and converting the Java object into data of JSON type.

The generating a web page based on the first data may include: determining a first widget to output the first data among widgets outputable from the web page by analyzing a structure of the first data; and mapping the first widget and the first data.

The mapping the first widget and the first data may include: recognizing an attribute value of the first widget; recognizing a key-value store corresponding to the attribute value of the first data; and applying the recognized key-value store to the first widget.

The widgets outputable from the web page may include at least one of a table type widget, a text area type widget or a button type widget.

The determining a first widget to output the first data among widgets outputable from the web page by analyzing a structure of the first data may include defining the first widget based on at least one of attributes included in the first data, and the attributes included in the first data may be at least one of a coordinate attribute, an underline attribute, a color attribute or a blink attribute.

The transmitting the web page to the web browser so that the web page is output through the web browser may include: generating an HTML (Hypertext Markup Language) code based on the web page; and transmitting the HTML code to the web browser.

The steps may further include: receiving a first user input associated with the first data from a user terminal; and converting the first user input to second data of JSON type.

The step may further include: converting the second data to a second data set; and transmitting the second data set to the mainframe.

The steps may further include: receiving a second user input related to customizing the web page from a user terminal; and changing the web page based on the second user input.

Another exemplary embodiment of the present disclosure provides a data conversion server. The data conversion server may include: a communication unit which transmits/receives data to/from a mainframe and a user terminal; and a processor which converts the data.

The processor may receive a first data set from the main frame via the communication unit, convert the first data set into first data of a JSON (JavaScript Object Notation) type for generating a web page, generate the web page based on the first data, and control the communication unit to transmit the web page to the web browser so that the web page is output through the web browser. Further, the web page may permit user interaction.

The processor may convert the first data set created in an EBCDIC (extended binary-coded decimal interchange code) type into UTF-16 (16-bit Unicode Transformation Format) type when converting the first data set into the first data of JSON type, store the first data set converted into the UTF-16 type as a Java object, and convert the Java object into data of JSON type.

The processor may determine a first widget to output the first data among widgets outputable from the web page by analyzing a structure of the first data when generating a web page based on the first data; and map the first widget and the first data.

The processor may recognize an attribute value of the first widget when mapping the first widget and the first data, recognize a key-value store corresponding to the attribute value of the first data, and apply the recognized key-value store to the first widget.

The widgets outputable from the web page may include at least one of a table type widget, a text area type widget or a button type widget. Further, the processor may define the first widget based on at least one of attributes included in the first data when determining a first widget to output the first data among widgets outputable from the web page by analyzing the structure of the first data, and the attributes included in the first data may include at least one of a coordinate attribute, an underline attribute, a color attribute or a blink attribute.

The processor may control the communication unit to generate an HTML (Hypertext Markup Language) code based on the web page and transmit the HTML code to the web browser when controlling the communication unit so as to transmit the web page to the web browser so that the web page is output through the web browser.

The communication unit may receive a first user input associated with the first data from a user terminal and the processor may convert the first user input received through the communication unit into second data of JSON type.

The processor may control the communication unit to convert the second data to a second data set and transmit the second data set to the mainframe.

The communication unit may receive a second user input related to customizing the web page from a user terminal, and the processor may change the web page based on the second user input received through the communication unit.

Technical solving means which can be obtained in the present disclosure are not limited to the aforementioned solving means and other unmentioned solving means will be clearly understood by those skilled in the art from the following description.

According to an exemplary embodiment of the present disclosure, a data converter server for displaying a data set of a mainframe in various forms in a user terminal and computer programs stored in a computer readable storage can be provided.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the detailed matters.

FIG. 1 is a diagram illustrated for describing examples of a mainframe, a data conversion server, and a user terminal in which various aspects of the present disclosure may be implemented.

FIG. 2 is a flowchart for describing an example of a method in which a data conversion server converts a data set received from a mainframe and transmits the converted data set to a web browser according to some exemplary embodiments of the present disclosure.

FIG. 3 is a flowchart for describing an example of a method in which the data conversion server converts the data set received from the mainframe into JSON type data according to some exemplary embodiments of the present disclosure.

FIG. 4 is a flowchart for describing an example of a method in which the data conversion server maps a widget and data according to some exemplary embodiments of the present disclosure.

FIG. 5 is a flowchart for describing an example of a method in which the data conversion server transmits a web page to the web browser according to some exemplary embodiments of the present disclosure.

FIG. 6 is a diagram for describing an example of the web page generated by the data conversion server according to some exemplary embodiments of the present disclosure.

FIG. 7 is a flowchart for describing an example of a method in which the data conversion server converts a user input received from the user terminal and transmits the converted user input to the mainframe according to some exemplary embodiments of the present disclosure.

FIG. 8 is a simple and general schematic view for an exemplary computing environment in which some exemplary embodiments of the present disclosure may be implemented.

### DETAILED DESCRIPTION

Various embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof.

Specifically, in “embodiment”, “example”, “aspect”, “illustration”, and the like used in the specification, it may not be construed that a predetermined aspect or design which is described is more excellent or advantageous than other aspects or designs.

Various aspects and features will be presented by a system which can include one or more apparatuses, terminals, servers, devices, components, and/or modules. It should also be appreciated and recognized that various systems can include additional apparatuses, terminals, servers, devices, components, and/or modules and/or that the various systems cannot include all of apparatuses, terminals, servers, devices, components, modules, and the like discussed in association with the drawings.

“Computer program”, “component”, “module”, “system”, and the like which are terms used in this specification may be used to be compatible with each other and refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers.

The components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

Hereinafter, like reference numerals refer to like or similar elements regardless of reference numerals and a duplicated description thereof will be omitted. Further, in describing an exemplary embodiment disclosed in the present disclosure, a detailed description of related known technologies will be omitted if it is determined that the detailed description makes the gist of the exemplary embodiment of the present disclosure unclear. Further, the accompanying drawings are only for easily understanding the exemplary embodiment disclosed in this specification and the technical spirit disclosed by this specification is not limited by the accompanying drawings.

The terminology used in this specification is for the purpose of describing embodiments only and is not intended to limit the present disclosure. In this specification, singular forms include even plural forms unless the context clearly indicates otherwise. It is to be understood that the terms “comprise” and/or “comprising” used in the specification are intended to be inclusive in a manner that does not exclude the presence or addition of one or more other components other than stated components.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to all of the case where X uses A, the case where X uses B, or the case where X uses both A and B. Further, it should be understood that the term “and/or” used in the specification designates and includes all available combinations of one or more items among enumerated related items.

The terms “information” and “data” used in the specification may also be often used to be exchanged with each other.

Suffixes “module” and “unit” for components used in the following description are given or mixed in consideration of easy preparation of the specification only and do not have their own distinguished meanings or roles.

The objects and effects of the present disclosure, and technical constitutions of accomplishing these will become obvious with reference to exemplary embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention of a user or an operator or usual practice.

However, the present disclosure is not limited to exemplary embodiments disclosed below but may be implemented in various different forms. However, the exemplary embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

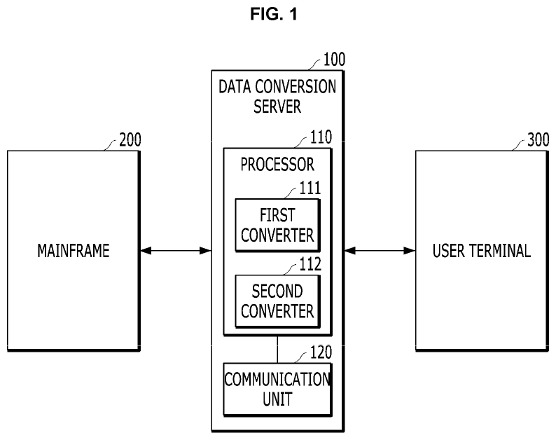

FIG. 1 is a diagram illustrated for describing examples of a mainframe, a data conversion server, and a user terminal in which various aspects of the present disclosure may be implemented.

According to some exemplary embodiments of the present disclosure, a data conversion system may include at least one of a data conversion server 100, a mainframe 200, or a user terminal 300. However, components described above are not required in implementing the data conversion system and the database conversion system may thus have components more or less than components listed above.

The data conversion server 100, the mainframe 200, and the user terminal 300 according to some exemplary embodiments of the present disclosure may mutually transmit and receive data for the data conversion system according to some exemplary embodiments of the present disclosure through a network.

The network according to the exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network presented in the present specification may use various wireless communication networks such as code division multi access (CDMA), time division multi access (TDMA), frequency division multi access (FDMA), orthogonal frequency division multi access (OFDMA), single carrier-FDMA (SC-FDMA), and other networks.

The network according to the exemplary embodiments of the present disclosure may be configured regardless of communication modes such as wired and wireless modes and constituted by various communication networks including a personal area network (PAN), a wide area network (WAN), and the like. Further, the network may be known World Wide Web (WWW) and may adopt a wireless transmission technology used for short-distance communication, such as infrared data association (IrDA) or Bluetooth.

The techniques described in the present specification may also be used in other networks in addition to the aforementioned networks.

In the present disclosure, the data conversion server 100 as a server for converting data of the mainframe 200 may include a processor 110 and a communication unit 120. Here, the processor 110 may include a first converter 111 and a second converter 112. However, components described above are not required in implementing the data conversion server 100 and the data conversion server 100 may thus have components more or less than components listed above. Here, respective components may be configured as separate chips, modules, or devices and may be included in one device.

The communication unit 120 may include one or more modules that enable communication between the data conversion server 100 and the communication system, between the data conversion server 100 and the mainframe 200, between the data conversion server 100 and the user terminal 300, or between the data conversion server 100 and a web browser (program).

In addition, the communication unit 120 may include one or more modules that connect the data conversion server 100 to one or more networks. The communication unit 120 may include at least one of a mobile communication module, a wireless Internet module, or a short-range communication module. According to some exemplary embodiments of the present disclosure, the communication unit 120 may receive a first data set from the mainframe 200. Here, the first data set may be one-dimensional type data. For example, in response to a predetermined byte value, attribute values of data may be placed on the data.

Meanwhile, the processor 110 of the data conversion server 100 may convert the first data set into first data of JavaScript Object Notation (JSON) type for generating a web page. Specifically, the first converter 111 of the processor 110 may convert a data type of the first data set into the JSON type. That is, the processor 110 may convert a one-dimensional type data set into JSON data of a structure type.

In addition, the processor 110 may generate the web page based on the first data. Specifically, the second converter 112 of the first processor 110 may map the first data and a first widget by analyzing the first data. Further, the second converter 112 may generate the web page including the first widget mapped with the first data.

The processor 110 may control the communication unit 120 to transmit the web page to the web browser. Here, the web page may be output through the web browser. Further, the web page may permit user interaction.

Meanwhile, the user terminal 300 may download the web page generated by the data conversion server 100 through a web browser program installed in the user terminal 300. Further, the user terminal 300 may output the web page.

That is, the processor 110 of the data conversion server 100 may provide a user with a user-friendly and modern web page by using various screen expression tools.

Meanwhile, the user may recognize the web page including the first widget mapped with the first data through the user terminal 300. Accordingly, the user does not need to recognize a data type (e.g., EBCDIC type) of the mainframe 200 when checking the web page including the information on the data of the mainframe 200 through the user terminal 300.

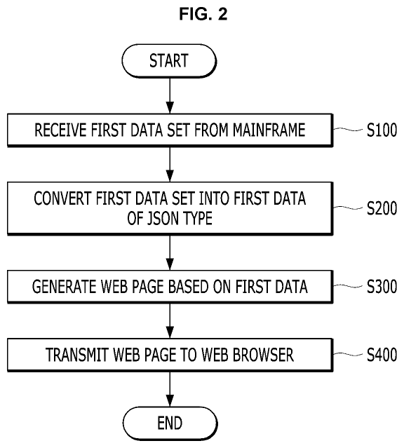

A detailed description of a method for converting the first data set received from the mainframe 200 and generating the web page and transmitting the web page to the web browser by the processor 110 of the data conversion server 100 will be made below with reference to FIGS. 2 to 6.

According to some exemplary embodiments of the present disclosure, the data conversion server 100 may further include a memory (not illustrated). Here, the memory stores data for supporting various functions of the data conversion server 100. The memory may store multiple application programs (or applications) driven by the data conversion server 100, and data and commands for operating the data conversion server 100.

At least some of the application programs may be downloaded from an external server through wired/wireless communication. Further, at least some of the application programs may be present in the data conversion server 100 from the time of shipment for basic functions (for example, data conversion, connection with another network via the mainframe or public network, and device sharing) of the data conversion server 100.

Meanwhile, the application program is stored in the memory and installed in the data conversion server 100 to be driven to perform an operation (or function) of the data conversion server 100 by the processor 110. The processor 110 generally controls an overall operation of the data conversion server 100 in addition to an operation related to the control of the data conversion server 100. The processor 110 processes a signal, data, information, and the like input or output through the components or drives the application program stored in the memory to provide or process information or a function appropriate for the user.

The processor 110 may control at least some of the components of the data conversion server 100 in order to drive the application program stored in the memory. Furthermore, the processor 110 may combine and operate at least two of the components of the data conversion server 100 in order to drive the application program.

At least some of the respective components may operate in cooperation with each other in order to implement the operation, the control, or a control method of the data conversion server 100 according to various exemplary embodiments described below. Further, the operation, the control, or the control method of the data conversion server 100 may be implemented on the data conversion server 100 by driving at least one application program stored in the memory.

According to software-wise implementation, exemplary embodiments such as a procedure and a function described in the present disclosure may be implemented by separate software modules. Each of the software modules may perform one or more functions and operations described in the specification. A software code may be implemented by a software application written by an appropriate program language. The software code may be stored in the memory and executed by the processor 110.

In the present disclosure, the mainframe 200 as an industrial term referring to a large-sized computer manufactured in a large company such as IBM is primarily used in a computing business required for enterprise activities of companies such as major companies or financial institutions and is configured by a centralization scheme rather than a distributed computing scheme. The program of the mainframe 200 may be prepared by a programming language such as COBOL.

According to some exemplary embodiments of the present disclosure, the mainframe 200 may include a mainframe database and an agent. However, the components described above are not required in implementing the mainframe 200 and the mainframe 200 may thus have components more or less than components listed above.

The mainframe database is a term collectively referred to as one or more data sets stored in the mainframe 200 and may include all of raw data stored in the mainframe 200. The mainframe database follows a programming language system of the mainframe 200 and may be configured with a code system of the mainframe 200. For example, the mainframe database may have an Extended Binary Coded Decimal Interchange Code (EBCDIC) system. The data set of the mainframe 200 may be a file holding a record organization. The data set may be organized into various logical records and block structures, which are determined by parameters including data set organization (DSORG), record format (RECFM), and the like. The data set may correspond to a table of a general relational database.

The agent of the mainframe 200 communicates with the data conversion server 100 and communicates with the mainframe database to allow the mainframe database to communicate with the data conversion server 100.

The mainframe 200 and the data conversion server 100 may establish a socket connection over the network. The mainframe 200 and the data conversion server may perform socket communication by a TCP or UDP scheme. The agent may become a connection point of the socket communication of the data conversion server 100 and the mainframe 200. The agent may interpret a programming language system of the data conversion server 100 and interpret the programming language system of the mainframe 200 to support communication between the data conversion server 100 and the mainframe 200. The agent may be a module for communication with the data conversion server 100. The agent may perform the socket communication with the data conversion server 100. The mainframe 200 and the data conversion server 100 may exist as separate computing devices and perform communication by using network communication. The agent may be a module that may decrypt information requested by the data conversion server 100 and perform processing and response thereto.

According to some exemplary embodiments of the present disclosure, the agent may receive a record request from the data conversion server 100. The data conversion server 100 may be connected to the mainframe 200 using address and port information of the mainframe 200. When the data conversion server 100 is connected to the mainframe 200, the agent may transmit to the data conversion server 100 a message that the data conversion server 100 is normally connected to the mainframe 200. Here, the record request may include a name and a record key of the data set stored in the mainframe 200.

The record request of the present disclosure may include information for requesting a specific record stored in the mainframe 200. The agent may request to the mainframe database a record identified by the record key in the data set identified by the name of the data set based on the name and the record key (or record number) of the data set. The name of the data set may include information for identifying the data set. The record key or the record number may include information for identifying which record among the records included in the data set is requested. The record request may be prepared by a language of the data conversion server 100. In this case, the agent may convert the record request into the language of the mainframe 200 and deliver the converted language to the mainframe database.

The agent may receive record data requested by the data conversion server 100 from the mainframe database and deliver the received record data to the data conversion server 100. The record data as a part of the data set of the mainframe 200 may be a record of a specific row corresponding to the record key of the data set and may have a record structure of the mainframe system. However, the present disclosure is not limited thereto and the data conversion server 100 may request the entire data set of the mainframe 200.

According to some exemplary embodiments of the present disclosure, the data conversion server 100 may request and receive the data set of the mainframe 200 and modify the requested and received data set to a widget type included in the web page and provide the widget type to the user in real time. Additionally, when the user modifies the corresponding data set, the data conversion server 100 may deliver to the mainframe 200 modifications so as to reflect the modifications to raw data stored in the mainframe 200.

In the present disclosure, the user terminal 300 may be included in an external computing device. Here, the user terminal 300 may be divided into a mobile/portable terminal and a stationary terminal according to whether the user terminal is movable. Again, the mobile terminal may be divided into a handheld terminal and a vehicle mounted terminal according to whether the user may directly carry the mobile terminal.

For example, the user terminal 300 may include a cellular phone, a smart phone, a desktop computer, a personal computer, a laptop computer, a digital broadcasting terminal, a digital TV, a digital signage, a personal digital assistants (PDA), a portable multimedia player (PMP), a navigation, a slate PC, a tablet PC, an ultrabook, a wearable device such as a smartwatch, a smart glass, or a head mounted display (HMD)), etc.

According to some exemplary embodiments of the present disclosure, the user terminal 300 may include the processor and the memory. However, components described above are not required in implementing the user terminal 300 and the user terminal 300 may thus have components more or less than components listed above. Here, respective components may be configured as separate chips, modules, or devices and may be included in one device.

The memory of the user terminal 300 stores data for supporting various functions of the user terminal 300. Specifically, the memory of the user terminal 300 may store multiple application programs (or applications) driven by the user terminal 300 and data and commands for operating the user terminal 300.

At least some of the application programs may be downloaded from an external server through wired/wireless communication. Further, at least some of the application programs may be present in the user terminal 300 from the time of shipment for basic functions (for example, data conversion, connection with another network via the mainframe or public network, and device sharing) of the user terminal 300.

Meanwhile, the application program is stored in the memory of the user terminal 300 and installed in the user terminal 300 to be driven to perform an operation (or function) of the user terminal 300 by the processor of the user terminal 300.

The processor of the user terminal 300 generally controls an overall operation of the user terminal 300 in addition to an operation related to the control of the user terminal 300. The processor of the user terminal 300 processes a signal, data, information, and the like input or output through the components or drives the application program stored in the memory of the user terminal 300 to provide or process information or a function appropriate for the user.

According to some exemplary embodiments of the present disclosure, the user terminal 300 may download the web page generated by the data conversion server 100 through a web browser program (application program) installed in the user terminal 300. Further, the user terminal 300 may output the web page. That is, the user may recognize the web page including the first widget mapped with the first data through the user terminal 300.

The user terminal 300 may include a user input unit. In this case, the user terminal 300 may receive the user input through the user input unit. Further, the user terminal 300 may transmit the user input to the data conversion server 100.

In this case, the data conversion server 100 may modify the data set of the mainframe 200 or modify the web page in response to the user input. That is, the user may create the web page with the help of the data conversion server 100 without changing the mainframe 200. Specifically, the user may easily change and/or generate the web page through various widgets provided by the data conversion server 100.

FIG. 2 is a flowchart for describing an example of a method in which a data conversion server converts a data set received from a main frame and transmits the converted data set to a web browser according to some exemplary embodiments of the present disclosure.

According to some exemplary embodiments of the present disclosure, the processor 110 of the data conversion server 100 may receive the first data set from the mainframe 200 through the communication unit 120 (S100). Here, the first data set may be one-dimensional type data. For example, in response to a predetermined byte value, attribute values of data may be placed on the data.

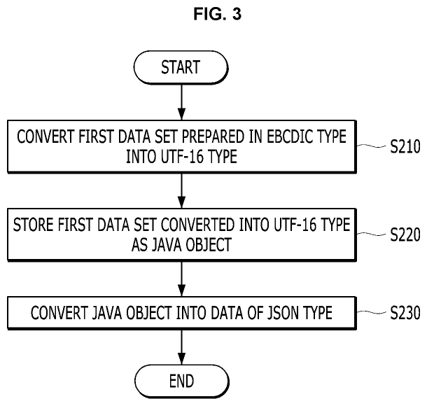

The processor 110 of the data conversion server 100 may convert the first data set into first data of JSON type for generating the web page (S200). Specifically, the first converter 111 of the processor 110 may convert a data type of the first data set into the JSON type. That is, the processor 110 may convert a one-dimensional type data set into JSON data of a structure type. A method in which the first converter 111 of the processor 110 converts the first data set into the data of JSON type will be described below in detail with reference to FIG. 3.

The processor 110 of the data conversion server 100 may generate the web page based on the first data (S300). Specifically, the second converter 112 of the processor 110 may analyze a structure of the first data. Further, the second converter 112 may determine the first widget to output the first data among the widgets outputable from the web page. In addition, the second converter 112 may generate the web page by mapping the first widget and the first data.

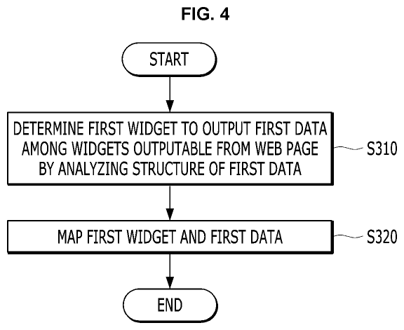

A method in which the second converter 112 of the processor 110 generates the web page will be described below in detail with reference to FIG. 4.

Meanwhile, the processor 110 of the data conversion server 100 may control the communication unit 120 to transmit the web page to the web browser.

FIG. 3 is a flowchart for describing an example of a method in which the data conversion server converts the data set received from the main frame into JSON type data according to some exemplary embodiments of the present disclosure.

According to some exemplary embodiments of the present disclosure, the first converter 111 included in the processor 110 of the data conversion server 100 may convert the first data set prepared in an Extended Binary Coded Decimal Interchange Code (EBCDIC) type into a 16-bit Unicode Transformation Format (UTF-16) type (S210).

The first converter 111 of the processor 110 may store the first data set converted into the UTF-16 type in the memory of the data conversion server 100 as a JAVA object (S220). In addition, the first converter 111 of the processor 110 may convert the Java object into the JSON type data (S230).

That is, the processor 110 of the data conversion server 100 may convert the first data set into the first data of JSON type. In this case, the processor 110 of the data conversion server 100 may generate the web page based on the first data of JSON type.

FIG. 4 is a flowchart for describing an example of a method in which the data conversion server maps a widget and data according to some exemplary embodiments of the present disclosure.

According to some exemplary embodiments of the present disclosure, the second converter 112 included in the processor 110 of the data conversion server 100 may analyze the structure of the first data. Further, the second converter 112 of the processor 110 may determine the first widget to output the first data among the widgets output from the web page by analyzing the structure of the first data (S310).

Specifically, the second converter 112 may determine the first widget of a type capable of expressing the first data among a table type widget, a text area type widget, and a button type widget by analyzing the structure of the first data.

However, the present disclosure is not limited thereto and the processor 110 of the data conversion server 100 may determine the first widget by receiving the user input.

According to some exemplary embodiments of the present disclosure, the second converter 112 of the processor 110 may map the first widget and the first data (S320).

Specifically, the second converter 112 may recognize the attribute value of the first widget. Further, the second converter 112 may recognize a Key-Value Store corresponding to the attribute value of the first widget among the first data. In addition, the second converter 112 may apply the recognized Key-Value Store to the first widget.

For example, the second converter 112 recognizes a key value corresponding to a coordinate value of a first area of the first widget to recognize the Key-Value Store corresponding to the attribute value of the first widget. In addition, the second converter 112 may generate the web page so as to display a value of the Key-Value Store corresponding to the attribute value of the first widget in the first area of the first widget.

According to some exemplary embodiments of the present disclosure, when the second converter 112 of the processor 110 determines the first widget to output the first data, the second converter 112 of the processor 110 may define the first widget based on at least one of the attributes included in the first data. Here, the attributes included in the first data may be at least one of a coordinate attribute, an underline attribute, a color attribute, or a blink attribute.

As an example, when the second converter 112 of the processor 110 defines the table type widget based on at least one of the attributes included in the first data, the second converter 112 of the processor 110 may define the table type widget so as to insert a first value into a first cell by recognizing the first value corresponding to the first cell according to a coordinate attribute. In addition, the second converter 112 may define the table type widget so as to insert values corresponding to a plurality of adjacent cells, respectively based on the first cell.

As another example, when the second converter 112 of the processor 110 inserts the first value into the first cell and the underline attribute corresponding to the first cell is included, the second converter 112 of the processor 110 may define the table type widget so as to display an underline in a row and/or a column including the first cell. Here, the underline attribute may be at least one of attributes to display the underline for the row or an attribute to display the underline for the column.

As yet another example, when the second converter 112 of the processor 110 inserts the first value into the first cell and then the blink attribute corresponding to the first cell is included, the second converter 112 of the processor 110 may define the table type widget so that the first value inserted into the first cell blinks.

As still yet another example, when the second converter 112 of the processor 110 inserts the first value into the first cell and then the color attribute corresponding to the first cell is included, the second converter 112 of the processor 110 may define the table type widget so that the first value inserted into the first cell is displayed with a color.

Meanwhile, the second converter 112 may generate the web page including a widget defined based on at least one of the attributes included in the first data.

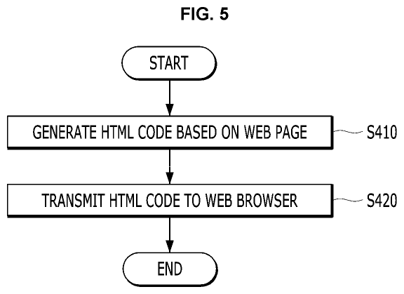

FIG. 5 is a flowchart for describing an example of a method in which the data conversion server transmits a web page to the web browser according to some exemplary embodiments of the present disclosure. According to some exemplary embodiments of the present disclosure, the processor 110 of the data conversion server 100 may generate an HTML code based on the web page generated based on the first data (S410).

Specifically, the processor 110 of the data conversion server 100 may convert a source code of the web page into the HTML code so as to output the web page from the user terminal 300 through the web browser.

Here, HTML means a set of codes inserted into a mark-up symbol or file (here, a web page including a widget to which the Key-Value Store of the first data is applied) for displaying information on the web browser.

The processor 110 of the data conversion server 100 may control the communication unit 120 to transmit the HTML code to the web browser (S420). Here, the web browser may be an HTML browser.

In this case, the user terminal 300 may output the web page by receiving the HTML through the web browser program installed in the user terminal 300.

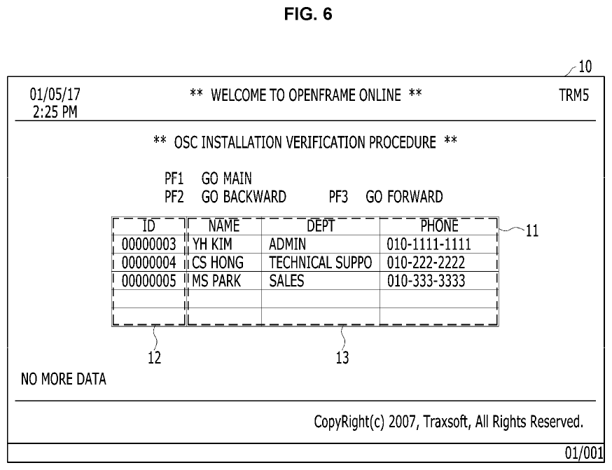

FIG. 6 is a diagram for describing an example the web page generated by the data conversion server according to some exemplary embodiments of the present disclosure.

According to some exemplary embodiments of the present disclosure, the web page may include the widget. Specifically, the web page may include the widget including the Key-Value store.

Specifically, the processor 110 of the data conversion server 100 may apply the data of the mainframe 200 onto the widget included in the web page according to the Key-Value store.

For example, the processor 110 may recognize the attribute value of the widget included in the web page. Further, the processor 110 may recognize the Key-Value store corresponding to the attribute value of the widget included in the web page among the data of the mainframe 200. In addition, the processor 110 may apply the recognized Key-Value Store to the widget included in the web page.

As a specific example, the processor 110 recognizes a key value corresponding to a coordinate value of a specific area of the widget included in the web page to recognize the Key-Value Store corresponding to the attribute value of the widget included in the web page. In addition, the processor 110 may generate the web page so as to display a value of the Key-Value Store corresponding to the attribute value of the widget included in the web page in the specific area of the widget included in the web page.

That is, the processor 110 of the data conversion server 100 may provide a user with a user-friendly and modern web page by using various screen expression tools.

Accordingly, the user does not need to recognize a data type (e.g., EBCDIC type) of the mainframe 200 when checking the web page including the information on the data of the mainframe 200 through the user terminal 300.

As illustrated in FIG. 6, the processor 110 of the data conversion server 100 may generate a web page 10 including a table type widget 11. Here, the table type widget 11 may include a key 12 and a value 13. However, a form of the web page 10 illustrated in FIG. 6 is just some exemplary embodiments and the present disclosure is not limited thereto.

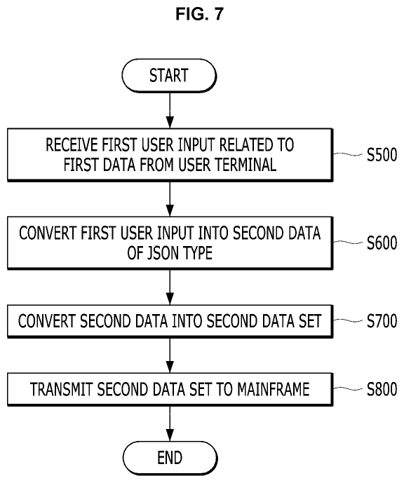

FIG. 7 is a flowchart for describing an example of a method in which the data conversion server converts a user input received from the user terminal and transmits the converted user input to the main frame according to some exemplary embodiments of the present disclosure.

According to some exemplary embodiments of the present disclosure, the communication unit 120 of the data conversion server 100 may receive the first user input related to the first data from the user terminal 300 (S500). Specifically, the user terminal 300 may output the web page related to the first data. Further, the user terminal 300 may receive the first user input from the output web page. In this case, the user terminal 300 may transmit the first user input to the data conversion server 100.

In this case, the processor 110 of the data conversion server 100 may convert the first user input into second data of JSON type. Further, the processor 110 of the data conversion server 100 may convert the second data into a second data set (S700).

Here, the second data set may be may be a data set different from the first data set previously received from the mainframe. Specifically, the second data set may be a data set in which the key-value of the first data set is partially changed.

Meanwhile, the processor 110 of the data conversion server 100 may control the communication unit 120 to transmit the second data set to the mainframe 200 (S800).

When the user modifies the first data set of the mainframe 200, the processor 110 of the data conversion server 100 transmits the second data set in which the first data set is modified to the mainframe 200 to modify the data set stored in the mainframe 200.

According to some other exemplary embodiments of the present disclosure, the communication unit 120 of the data conversion server 100 may receive a second user input related to customizing the web page from the user terminal. Further, the processor 110 of the data conversion server 100 may change the web page based on the second user input.

For example, the communication unit 120 may receive the second user input to add an image to one area of the web page from the user terminal 300. In this case, the processor 110 may add the image to one area of the web page and transmit the added image to the web browser.

Accordingly, the user may create the web page with the help of the data conversion server 100 without changing the mainframe 200. Specifically, the user may easily generate and change the web page through various widgets provided by the data conversion server 100.

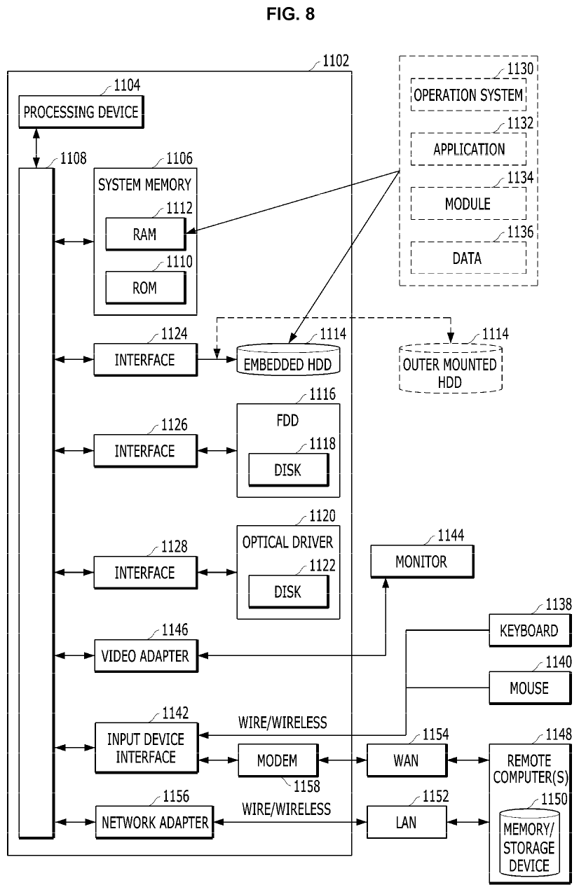

FIG. 8 is a simple and general schematic view for an exemplary computing environment in which exemplary embodiments of the present disclosure may be implemented.

The present disclosure has generally been described above in association with a computer executable command which may be executed on one or more computers, but it will be well appreciated by those skilled in the art that the present disclosure can be implemented through a combination with other program modules and/or a combination of hardware and software. In general, the module in the present specification includes a routine, a procedure, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a mainframe computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As not a limit but an example, the computer readable media may include both computer readable storage media and computer readable transmission media.

The computer readable storage media include volatile and non-volatile media, temporary and non-temporary media, and movable and non-movable media implemented by a predetermined method or technology for storing information such as a computer readable command, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by configuring or changing at least one of characteristics of the signal so as to encode information in the signal. As not a limit but an example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114 (for example, EIDE and SATA)—the internal hard disk drive (HDD) 1114 may also be configured for an external purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or recorded in other high-capacity optical media such as the DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an external drive includes, for example, at least one of a universal serial bus (USB) or an IEEE 1394 interface technology or both of them.

The drives and the computer readable media associated therewith provide non-volatile storage of the data, the data structure, the computer executable command, and others. In the case of the computer 1102, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached by the RAM 1112. It will be well appreciated that the present disclosure may be implemented in various operating systems which are commercially usable or a combination of the operating systems.

A user may input commands and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a server computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158, is connected to a communication server on the WAN 1154, or has other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and a Bluetooth wireless technology. Accordingly, communication may be a predefined structure like the network in the related art or just ad hoc communication between at least two devices.

The Wi-Fi enables connection to the Internet, and the like without a wired cable. The Wi-Fi is a wireless technology such as a device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps(802.11a) or 54 Mbps (802.11b) in unlicensed 2.4 and 5 GHz wireless bands or operate in a product including both bands (dual bands).

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be analyzed that the implementation determination departs from the scope of the present disclosure.

Various exemplary embodiments presented herein may be implemented as manufactured articles using a method, an apparatus, or a standard programming and/or engineering technique. The term “manufactured article” includes computer programs or media which are accessible by a predetermined computer-readable device. For example, a computer readable storage includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. The term “machine-readable media” include a wireless channel and various other media that can store, possess, and/or transfer command(s) and/or data, but are not limited thereto.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but it does not mean that the method claims are limited to the presented specific order or hierarchical structure.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be analyzed within the widest range which is consistent with the principles and new features presented herein.

What is claimed is:

1. A computer readable medium containing a computer program,
wherein the computer program includes commands which cause a computer to execute steps, the steps comprising:
receiving a first data set from a mainframe;
converting the first data set into first data of a JSON (JavaScript Object Notation) type;
generating a web page based on the first data; and
transmitting the web page to the web browser so that the web page is output through the web browser,
wherein the webpage includes a user interface that allows user interaction.

2. The computer readable medium of claim 1, wherein the converting the first data set into first data of a JSON (JavaScript Object Notation) type for generating a web page comprises:
converting the first data set created in an EBCDIC (extended binary-coded decimal interchange code) type into UTF-16 (16-bit Unicode Transformation Format) type;
storing the first data set converted into the UTF-16 type as a Java object; and
converting the Java object into data of JSON type.

3. The computer readable medium of claim 1, wherein the generating a web page based on the first data comprises:
determining a first widget to output the first data among widgets outputable from the webpage by analyzing a structure of the first data; and
mapping the first widget and the first data.

4. The computer readable medium of claim 3, wherein the mapping the first widget and the first data comprises:
recognizing an attribute value of the first widget;
recognizing a key-value store corresponding to the attribute value of the first data; and
applying the key-value store to the first widget;

5. The computer readable medium of claim 3, wherein the widgets include at least one of a table type widget, a text area type widget or a button type widget.

6. The computer readable medium of claim 3, wherein the determining a first widget to output the first data among widgets outputable from the webpage by analyzing a structure of the first data comprises defining the first widget based on at least one of attributes included in the first data, and
wherein the attributes included in the first data include at least one of a coordinate attribute, an underline attribute, a color attribute or a blink attribute.

7. The computer readable medium of claim 1, wherein the transmitting the web page to the web browser so that the web page is output through the web browser comprises:
generating an HTML (Hypertext Markup Language) code based on the web page; and
transmitting the HTML code to the web browser.

8. The computer readable medium of claim 1, further comprising:
receiving a first user input associated with the first data from a user terminal; and
converting the first user input to second data of JSON type.

9. The computer readable medium of claim 8, further comprising:
converting the second data to a second data set; and
transmitting the second data set to the mainframe.

10. The computer readable medium of claim 8, further comprising:
receiving a second user input related to customizing the web page from a user terminal; and
changing the web page based on the second user input.

11. A data conversion server, comprising:
a communication unit; and
a processor configured to:
receive a first data set from the main frame via the communication unit;
convert the first data set into first data of a JSON (JavaScript Object Notation) type;
generate the web page based on the first data; and
control the communication unit to transmit the web page to the web browser so that the web page is output through the web browser,
wherein the webpage includes a user interface that allows user interaction.

12. The data conversion server of claim 11, wherein the processor is further configured to:
convert the first data set created in an EBCDIC (extended binary-coded decimal interchange code) type into UTF-16 (16-bit Unicode Transformation Format) type when converting the first data set into the first data;
store the first data set converted into the UTF-16 type as a Java object; and
convert the Java object into data of JSON type.

13. The data conversion server of claim 11, wherein the processor is further configured to:
determine a first widget to output the first data among widgets outputable from the webpage by analyzing a structure of the first data when generating a web page based on the first data; and
map the first widget and the first data.

14. The data conversion server of claim 13, wherein the processor is further configured to:
recognize an attribute value of the first widget when mapping the first widget and the first data;
recognize a key-value store corresponding to the attribute value of the first data; and
apply the key-value store to the first widget.

15. The data conversion server of claim 13, wherein the widgets include at least one of a table type widget, a text area type widget or a button type widget.

16. The data conversion server of claim 13, wherein the processor is further configured to define the first widget based on at least one of attributes included in the first data when determining a first widget to output the first data among widgets outputable from the webpage,
wherein the attributes included in the first data include at least one of a coordinate attribute, an underline attribute, a color attribute or a blink attribute.

17. The data conversion server of claim 11, wherein the processor is further configured to:
generate an HTML (Hypertext Markup Language) code based on the web page when transmitting the web page to the web browser; and
control the communication unit to transmit the HTML code to the web browser.

18. The data conversion server of claim 11, wherein the communication unit is further configured to receive a first user input associated with the first data from a user terminal,
wherein the processor is further configured to convert the first user input received through the communication unit into second data of JSON type.

19. The data conversion server of claim 18, wherein the processor is further configured to:
convert the second data to a second data set; and
transmit the second data set to the mainframe.

20. The data conversion server of claim 18, wherein the communication unit is further configured to receive a second user input related to customizing the web page from a user terminal, and
wherein the processor is further configured to change the web page based on the second user input.
